(19) United States
(12) Patent Application Publication
(10) Pub. No.: US 2023/0366775 A1
(43) Pub. Date: Nov. 16, 2023

(54) METHOD, AERIAL VEHICLE AND SYSTEM FOR DETECTING A FEATURE OF AN OBJECT WITH A FIRST AND A SECOND RESOLUTION

(71) Applicant: TOP seven GmbH & Co. KG, Starnberg (DE)

(72) Inventor: Ulrich SENG, Starnberg (DE)

(21) Appl. No.: 18/355,540

(22) Filed: Jul. 20, 2023

Related U.S. Application Data
(63) Continuation of application No. PCT/EP2022/051278, filed on Jan. 20, 2022.

(30) Foreign Application Priority Data
Jan. 22, 2021 (DE) 102021200583.7

(51) Int. Cl. G01M 5/00; G05D 1/00; G06T 7/00; G06T 7/70; G06V 20/10; G06V 20/17; B64U 10/13; F03D 17/00

(52) U.S. Cl. CPC G01M 5/0075; G05D 1/0094; G05D 1/0088; G01M 5/0033; G01M 5/0091; G06T 7/0002; G06T 7/70; G06V 20/176; G06V 20/17; B64U 10/13; F03D 17/003; G06T 2207/10148; G06T 2207/10032; B64U 2201/10; B64U 2101/30

(57) ABSTRACT

Embodiments according to a first and second aspect of the present invention are based on the core idea of flying along the object for detecting a feature of an object and detecting at least a part of the object with a capturing unit with a first resolution and providing, for those areas of the object that comprise the feature, images with the second resolution that is higher than the first resolution.

### CROSS-REFERENCE TO RELATED APPLICATIONS

This application is a continuation of copending International Application No. PCT/EP2022/051278, filed Jan. 20, 2022, which is incorporated herein by reference in its entirety, and additionally claims priority from German Application No. 102021200583.7, filed Jan. 22, 2021, which is also incorporated herein by reference in its entirety.

Embodiments according to the present invention relate to a method, aerial vehicles and systems for detecting a feature of an object. Further embodiments relate to AI (artificial intelligence) supported inspections of wind turbines with drones.

### BACKGROUND OF THE INVENTION

Wind power plants form an integral part of a sustainable energy supply. The use of the inexhaustible resource wind enables emission-free and safe production of power. While the type of energy generation by converting mechanical energy into electrical energy does not pose any immediate risks, it is still of great importance to regularly maintain and inspect the plants themselves. Due to the high power and respective dimensioning of modern wind power plants, the same have to withstand very high mechanical forces over a long period of many years. Therefore, damages should be detected in time to be eliminated, not only with regard to the safety of the plant, but also with regard to the efficiency of the plant, for example in the case of damages to the rotors of the wind turbines, which can reduce the efficiency of the plant.

One of the main problems is the size of modern wind power plants as well as the hard accessibility of a large part of the surface of the plant. Conventional approaches include the usage of climbers inspecting the plants and documenting damages. Apart from the inherent danger to the climbers, such works are accompanied by high costs due to the necessity of specially trained personnel and the omission of the power production of the respective wind turbine during the entire time of the inspection. Above that, due to the availability and speed of such climbers, no sufficiently short inspection intervals are possible for the plurality of plants of modern wind power parks for maintaining the same.

Considering this, there is a need for a concept providing an improved tradeoff between speed and accuracy of an inspection of wind power plants at low cost. Further, a respective concept is to comprise good scalability to ensure sufficiently short inspection intervals also for a plurality of plants of a wind power park e.g. for legally required repetitive inspections.

### SUMMARY

According to an embodiment, a method for detecting a damage of an object may have the steps of: (a) flying along the object and optically detecting at least a part of the object by at least one capturing unit with the first resolution to generate a plurality of images, wherein each image represents an at least partly different area of the object, (b) evaluating the plurality of images to classify the generated images into images that do not include the damage and into images that include the damage, and (c) optically detecting again those areas of the object whose allocated images include the damage with a second resolution that is higher than the first resolution.

According to another embodiment, a method for detecting a damage of an object may have the steps of: (a) flying along the object and optically detecting at least a part of the object by at least one capturing unit to generate a plurality of images, wherein each image represents an at least partly different area of the object, and wherein, for one area, an image with the first resolution and a plurality of partial images, each with a second resolution that is higher than a first resolution, are generated, (b) evaluating the plurality of images to classify the generated images into images that do not include the damage and into images that include the damage, and (c) providing the partial images of those areas of the object whose allocated images include the damage.

According to another embodiment, an unmanned aerial vehicle, e.g., drone for detecting a damage of an object, may have: at least one capturing unit for generating images by optical detection, wherein the unmanned aerial vehicle can be controlled to fly along the object and to optically detect at least part of the object by the capturing unit with a first resolution to generate a plurality of images, wherein each image represents an at least partly different area of the object and optically detect again those areas of the object whose allocated images include the damage with a second resolution that is higher than a first resolution; wherein the unmanned aerial vehicle is configured to transmit the plurality of images to an external computer, e.g., laptop computer that classifies the generated images into images that do not include the damage and into images that include the damage, receive information from the external computer that indicate the areas of the object to be optically detected by the second resolution, or wherein the unmanned aerial vehicle includes a computer that is configured to evaluate the plurality of images to classify the generated images into the images that do not include the damage and into the images that include the damage.

According to another embodiment, an unmanned aerial vehicle, e.g., drone, for detecting a damage of an object may have: at least one capturing unit for generating images by optical detection, wherein the unmanned aerial vehicle can be controlled to fly along the object and optically detect at least a part of the object by the capturing unit to generate a plurality of images, wherein each image represents an at least partly different area of the object and generate, for each area, an image with a first resolution and a plurality of partial images, each with a second resolution that is higher than the first resolution.

According to another embodiment, a system for detecting a damage of an object may have: an unmanned aerial vehicle, e.g., a drone, wherein the unmanned aerial vehicle can be controlled to fly along the object to optically detect at least a part of the object by at least one capturing unit with a first resolution to generate a plurality of images, wherein each image represents an at least partly different area of the object, wherein the system is configured to evaluate the plurality of images to classify the generated images into images that do not include the damage and into images that include the damage and wherein the unmanned aerial vehicle can be controlled to optically detect again those areas of the object whose allocated images include the damage with a second resolution that is higher than a first resolution.

According to another embodiment, a system for detecting a damage of an object may have: an unmanned aerial vehicle, e.g., drone, wherein the unmanned aerial vehicle can be controlled to fly along the object and optically detect at least a part of the object by the capturing unit to generate a plurality of images, wherein each image represents an at least partly different area of the object and generate, for each area, an image with a first resolution and the plurality of partial images, each with a second resolution that is higher than the first resolution, wherein the system is configured to evaluate the plurality of images to classify the generated images into images that do not include the damage and into images that include the damage and provide the partial images of those areas of the object whose allocated images include the damage, e.g., for classifying or cataloging the detected damages.

Embodiments according to a first aspect of the present invention provide a method for detecting a feature of an object, wherein the method comprises a step (a) that comprises flying along the object and optically detecting at least a part of the object by at least one capturing unit with a first resolution to generate a plurality of images, wherein each image represents an at least partly different area of the object. Further, the method includes a step (b) that comprises evaluating the plurality of images to classify the generated images into images that do not include the feature and into images that include the feature. Above that, the method includes a step (c) that comprises optically detecting again those areas of the object whose allocated images include the feature with a second resolution that is higher than the first resolution.

Further embodiments according to a second aspect of the present invention provide a method for detecting a feature of an object, wherein the method includes a step (a) that comprises flying along the object and optically detecting at least a part of the object by at least one capturing unit to generate a plurality of images, wherein each image represents an at least partly different area of the object and wherein, for one area, an image with a first resolution and a plurality of partial images, each with a second resolution that is higher than the first resolution, are generated. Above that, the method includes a step (b) that comprises evaluating the plurality of images to classify the generated images into images that do not include the feature and into images that include the feature. Further, the method includes a step (c) that comprises providing the partial images of those areas of the object whose allocated images include the feature.

Further embodiments according to the first aspect of the present invention provide an unmanned aerial vehicle, for example a drone, for detecting a feature of an object with at least one capturing unit for generating images by optical detection. Here, the unmanned aerial vehicle can be controlled to fly along the object and to optically detect at least a part of the object by the capturing unit with a first resolution to generate a plurality of images, wherein each image represents an at least partly different area of the object. Above that, the unmanned aerial vehicle can be controlled to optically detect again those areas of the object whose allocated images include the features with a second resolution that is higher than a first resolution.

Further embodiments according to the second aspect of the present invention provide an unmanned aerial vehicle, for example a drone, for detecting a feature of an object with at least one capturing unit for generating images by optical detection. Here, the unmanned vehicle can be controlled to fly along the object and to optically detect at least a part of the object by the capturing unit to generate a plurality of images, wherein each image represents an at least partly different area of the object. Above that, the unmanned aerial vehicle can be controlled to generate, for each area, an image with a first resolution and a plurality of partial images, each with a second resolution that is higher than the first resolution.

Further embodiments according to the first aspect of the present invention provide a system for detecting a feature of an object with an unmanned aerial vehicle, for example a drone, wherein the unmanned aerial vehicle can be controlled to fly along the object to optically detect at least a part of the object by at least one capturing unit with a first resolution to generate a plurality of images, wherein each image represents an at least partly different area of the object. Further, the system is configured to evaluate the plurality of images to classify the generated images into images that do not include the feature and into images that include the feature. Here, the unmanned aerial vehicle can be controlled to optically detect again those areas of the objects whose allocated images include the feature with a second resolution that is higher than a first resolution.

Further embodiments according to the second aspect of the present invention provide a system for detecting a feature of an object with an unmanned aerial vehicle, for example a drone, wherein the unmanned aerial vehicle can be controlled to fly along the object and to optically detect at least a part of the object by the capturing unit to generate a plurality of images, wherein each image represents an at least partly different area of the object. Above that, the unmanned aerial vehicle can be controlled to generate, for each area, an image with a first resolution and a plurality of partial images, each with a second resolution that is higher than the first resolution. Further, the system is configured to evaluate the plurality of images to classify the generated images into images that do not include the feature and into images that include the feature, and to provide the partial images of those areas of the object whose allocated images include the feature, for example for classifying or cataloging the detected features.

Embodiments according to the first and second aspects of the present invention are based on the core idea to fly along the object for detecting a feature of an object and to detect at least a part of the object with a capturing unit with a first resolution and to provide, for those areas of the object that comprise the feature, images with a second resolution that is higher than the first resolution, e.g. by detecting again such an area (first aspect) with the second resolution or by generating several partial images with the second resolution for each area and providing those partial images that include the feature.

The object can be a large and difficult to access object, such as a wind power plant, an oil platform, a bridge, a crane, a factory plant, a refinery or a ship. The feature of the object can be, for example, damages of the object. According to embodiments, an inventive method can be used to detect these damages, for example in the form of cracks, holes, deviations from geometric standards, such as bends, rust infestation or other indicators which allow conclusions on the structural integrity of the object.

By flying along the object, for example with an unmanned aerial vehicle such as a drone, such an object can be detected with little time and resource effort. In particular, the employment of persons for the detection itself, such as climbers in wind power plants can be omitted, whereby not only costs can be saved but also endangering people can be prevented. Above that, by flying along the object, parts of the object can be detected which would otherwise not be accessible. Detecting at least part of the object with the first resolution and detecting areas of the object again with the second resolution that is higher than the first resolution allows a very good trade-off between speed and accuracy of feature detection, as, for example, not the entire object has to be scanned with the higher resolution which can result in high time and data effort but only areas where, based on the detection with the first resolution, damages cannot be excluded or where damages are likely. In other words, an inventive approach consists of generating new images with higher resolution of those areas of the object including a defect or another feature of interest, after detecting and classifying images of an object.

Simply put, based on a plurality of images with the first resolution, coarse detection of the object or of features of the object can take place. These images can be evaluated and classified with respect to the feature, such as a damage, to detect again those areas of the object whose allocated images include the feature with the second higher resolution. Thus, based on images with the second resolution, for example small damages can be detected with high accuracy. The evaluation of the plurality of images can take place in an automated manner, for example based on approaches from machine learning or manually, for example by a person. Further, the evaluation of the plurality can take place in a partly automated manner, for example with automated methods supporting a person in the evaluation.

Here, flying along again after evaluation of the plurality of images at the ground to generate new images with the second evaluation can be performed, or the evaluation can take place during the flight, i.e. flying along the object and optically detecting at least a part of the object. For generating new images with higher resolution, the distance of the capturing unit to the object can be reduced or the zoom setting of the capturing unit can be changed. Above that, for example, based on a previous image classification, a raster image can be generated, wherein each partial image of the raster image has the second higher resolution.

Further, for example independent of an evaluation of the images regarding the features, a plurality of partial images, each with the second resolution, can be generated for images of a detection of a part of the object with the first resolution. Thus, when flying along the object once, the entire data amount for evaluation, for example with respect to damages of the object, can be generated. This can, for example have advantages when a drone for flying along and detecting the object only has small computing power, which is not sufficient to evaluate the images but which is configured to detect and store a large amount of data. Further, integral scanning of the object can take place, which consists, for example, of a plurality of images with the first resolution, wherein, for a plurality or even every image of the images with the first resolution, a plurality of partial images with the second resolution is provided, such that a data set with multi-stage accuracy for object description is available. This can have advantages, for example in particular safety-critical applications where uninterrupted proof about the state of the object is needed. Further, such a data set can provide and intuitive option for evaluation, for example for a person. For inspecting for damages, the person can quickly consider, for example from an overview of the object in the form of 3D model consisting of the images of the first resolution, parts of the object by partial images with the second resolution stored for a plurality of or even all images of the first resolution and important areas of the object in more detail.

Analogously to the above explanations, the plurality of images with the first resolution as well as the plurality of partial images with the second resolution can be evaluated, for example, in an automated manner in order to classify the generated images into images that do not include the feature and into images that include the feature, such that, for example, partial images of those areas of the object whose allocated images include the feature can be provided to and, for example, highlighted for the person. Simply put, images with the first resolution can be generated together with high-resolution raster images with the second resolution, the images can be classified and based on the classification, partial images, for example, raster image of the images representing defective areas can be provided. Here, it should be noted that the evaluation of the plurality of images and/or partial images can take place in an automated or partially automated or manual manner.

In other words, during the first time of flying along, in addition to the first images needed for the evaluation, for example an evaluation on the ground by means of a laptop, for each image, for example, automatically also a raster image with a higher resolution, for example a plurality of partial images each with the second resolution can be generated. When using an unmanned aerial vehicle, for example a drone including the capturing unit, the drone can stop at a waypoint of its flight trajectory, generate the first image and then generate the high-resolution raster image immediately from the same position. For increasing the resolution, for example a zoom lens can be used. Further, for increasing the resolution, the capturing unit can also comprise a plurality of cameras, such as two or three cameras. Above that, the capturing unit can comprise a plurality of lenses or camera lenses (multi-lens camera) for increasing the resolution. After classifying images including features, the high-resolution images with the features can be represented directly from the raster images. This means no second flight has to take place, since all images with highest resolution are already present and only a selection has to be made.

Above that, for example automated evaluation of the images, for example images with the first resolution, or the images with the second resolution, can be performed during or after flying along the object. Depending on the application or existing hardware, for example during the flight, it can be decided directly after detecting an image with the first resolution by evaluating the image or classifying the image whether further images are detected with the second higher resolution of the associated area of the object. Further, as discussed above, also for at least a part of the object, both one or several images with the first resolution and the associated one or several images with the first resolution, a plurality of images with the second, higher resolution can be generated and the evaluation or classification can take place during the flight, i.e., during flying along or after flying along based on any combination of the images.

The evaluation or classification can also be performed after flying along the object, i.e., after flying along the object for generating the images with the first resolution and prior to flying along the object again for generating images with the second resolution on an external computer, i.e., for example a computer, e.g., laptop which is not part of the capturing unit or an unmanned aerial vehicle, such as a drone.

Thus, methods according to the present invention allow exact scanning of an object with little time and resource effort.

In further embodiments according to the first aspect of the present invention, step (b) is performed after flying along the object and step (c) includes approaching those areas of the object whose allocated images include the feature. By, for example, automated evaluation of images after flying along the object, preprocessing can take place based on the images with the first resolution from step (a), based on which step (c) can be performed, such that, for example, only those areas of the object whose allocated images include the features are detected again with the second resolution. Thereby, significant time and data savings can be obtained.

By, for example, automated evaluation of the plurality of images after flying along the object, above that, evaluation can take place on an external computer, such that, for example, an unmanned aerial vehicle for flying along the object does only have to fulfil low hardware requirements. Further, in particular for large objects, restoring the flight ability of the aerial vehicle after flying along can be needed, which can be performed at the same time with the evaluation in a time saving manner. Step (c) can further be performed after step (b) and, for example, after the above-discussed intermediate landing. Simply put, the evaluation of the images can take place after the flight and subsequently flying along the object again to generate images of the defective areas with the higher resolution.

In embodiments according to the first aspect of the present invention, the capturing unit generates one image each with the same focal length in step (a) and in step (c). Further, the object is approached in step (a), such that the capturing unit has a first distance to the object when generating an image and such that the object is approached in step (c), such that the capturing unit has a second distance to the object that is lower than the first distance when generating an image.

Thereby, a simple and cost-effective capturing unit having only a single focal length can be used. Increasing the resolution is accordingly obtained by reducing the distance from the capturing unit to the object in step (c).

In embodiments according to the first aspect of the present invention, the object is approached in step (a) and in step (c) such that the capturing unit has the same or similar distance to the object when generating an image. Further, the capturing unit generates an image with a first focal length in step (a) and an image with a second focal length in step (c), wherein the second focal length is greater than the first focal length. Accordingly, increasing the resolution can take place by changing the focal length of a lens of the capturing unit, for example by changing a zoom setting or exchanging the lens. The capturing unit can be converted, for example, during an intermediate stop in order to detect images with the second focal length in step (c). Further, the capturing unit can also be equipped with cameras of different focal lengths, such that steps (a) and (c) can also be performed during a single flight.

In embodiments according to the first aspect of the present invention, the capturing unit uses, in step (a) at least one of a first camera with the first focal length, a first lens with the first focal length and/or a first camera lens with the first focal length or a zoom lens with a first zoom setting according to the first focal length. Above that, step (c) comprises replacing the first camera of the capturing unit by a second camera with the second focal length and/or replacing the first lens of the capturing unit by a second lens with the second focal length and/or replacing the first camera lens of the capturing unit with a second camera lens with the second focal length or setting the zoom lens of the capturing unit to a second zoom setting according to the second focal length. Both changing the camera, the lens and/or the camera lens as well as changing the zoom setting can be performed during an intermediate landing or also during flying along the object, e.g., in automated manner. By changing at least one of camera, lens, camera lens and/or zoom setting, increasing the resolution can be performed without changing the detecting distance, i.e., the distance of the capturing unit to the object, such that, for example when flying along the object in an automated or autonomous manner, no changes of waypoints determining the trajectory of the flying along has to take place.

In embodiments according to the first aspect of the present invention, optically detecting again the area in step (c) includes generating a plurality of partial images of the area, each with the second resolution. Here, step (c) can include, for example, in particular the above described approaching of those areas of the object whose associated images include the feature. Simply put, a raster image with a higher resolution of the respective area can be generated. In that way, damages can be detected reliably and accurately.

In embodiments according to the first aspect of the present invention, position and/or location information of the capturing unit is allocated to each image generated in step (a). Further, in step (c), the areas of the object that are to be flown along are determined by using the position and/or location information of the images including the feature. Simply put, waypoints for flying along again or for approaching can be generated based on the position/location information of the capturing unit. In that way, when approaching the object again, a trajectory can be generated, which includes, for example, only those waypoints that are suitable for detecting areas including possible damages. Accordingly, approaching or flying along the object again can be performed for generating images with the second resolution with little time effort.

In embodiments according to the first aspect of the present invention, flying along the object takes place with an unmanned, uninhabited or unpiloted aerial vehicle, UAV, for example a drone that includes the capturing unit. Further, step (b) comprises transmitting the images generated in step (a) from the unmanned aerial vehicle to a computer, such as a laptop computer and evaluating the images by the computer. Here, evaluating the images includes evaluating the images in an automated manner, for example part of the evaluation be performed in automated manner or also the entire evaluation of the image. With sufficiently fast data transmission between computer and aerial vehicle, optically detecting again in step (c) can take place during flying along of step (a), such that selecting those areas of the object that are detected with the second resolution can take place based on the images with the first resolution during flying along. By transferring the evaluation to an external computer, for example a remote computer, an aerial vehicle having low hardware requirements can be used. Above that, transmitting and evaluating the images by the computer can also be performed during landing, for example for preparing for approaching the object again for generating the images with the second resolution.

In embodiments according to the first aspect of the present invention, the unmanned aerial vehicle flies along the object autonomously in step (a). Further, step (b) includes generating waypoints by using the position and/or location information of the images including the feature and transmitting the waypoints, for example from the above described computer to the unmanned aerial vehicle. Above that, in step (c), the unmanned aerial vehicles approaches the areas of the object in autonomously by using the waypoints. Thereby, fully autonomous detection of the object or the feature of the object can be performed. By the waypoints, a time-efficient trajectory can be planned by which the respective areas of the objects can be detected with the second resolution in step (c). The waypoints can be produced, for example, based on a CAD model of the object. Thereby, the model can be improved by detecting the object and based thereon the waypoints can be adapted.

In embodiments according to the first aspect of the present invention, flying along the object with an unmanned aerial vehicle, e.g., drone, including the capturing unit is performed autonomously. Above that, the unmanned aerial vehicle includes a computer, wherein step (b) includes evaluating the images and generating waypoints by using the positon and/or location information of the images including the feature by the computer of the unmanned aerial vehicle. Here, evaluating the images includes automated evaluation of the images, the evaluation can take place, for example, in a fully automated or partly automated manner. Additionally, in step (c), the unmanned aerial vehicle approaches areas of the object autonomously by using the waypoints. By providing the computing power for evaluating the images and for generating the waypoints by the unmanned aerial vehicle, detection of the object or the feature of the object can be performed by flying along once and thereby in a time-efficient manner. Generating the waypoints can also include adapting existing waypoints, such that the unmanned aerial vehicle adapts its own flight trajectory during capturing the images based on the evaluation of the images.

In embodiments according to the first aspect of the present invention, steps (a) to (c) are performed during flying along the object such that in step (a) an image of an area is generated and in step (b) the image generated in step (a) is classified for a further area prior to generating an image. Above that, steps (a) to (c) are performed during flying along the object such that when in step (b) the image is classified as including the feature, in step (c) the area is optically detected again prior to generating the further image before an image is generated for the further area and such that, when in step (b) the feature is classified as not including the feature, an image is generated for the further area. Thus, when flying along the object once, the feature or the object can be detected. By classifying the images generated in step (a), capturing images with the second higher resolution, which do not include the feature, i.e., for example a damage of the object, can be prevented, such that merely relevant information is detected. In other words, the evaluation of the images can be performed during the flight and images with the higher resolution can be generated, for example, only of defective areas.

In embodiments according to the first aspect of the present invention, the capturing unit generates an image with the same focal length both in step (a) and in step (c). Above that, the object is approached in step (a) such that the capturing unit has a first distance to the object when generating an image. Further, in step (c), the distance of the capturing unit to the object is reduced to a second distance that is less than the first distance. Simply put, the higher resolution is obtained by a smaller distance to the object. Reducing the distance can be realized simply and quickly by adapting the flight trajectory.

In embodiments according to the first aspect of the present invention, the object is approached in step (a) such that the capturing unit has a first distance to the object when generating an image and the capturing unit generates an image with a first focal length. Further, in step (c), the distance of the capturing unit to the object is the same or similar to the first distance and the capturing unit generates an image with a second focal length that is greater than the first focal length. Thus, for example, when detecting the object autonomously, the predetermined waypoint can be maintained, such that no additional adaptation of the flight trajectory is needed. Here, for example, merely the period can be increased during which the unmanned aerial vehicle is at the respective waypoint to generate images with the second resolution. The distance of the capturing unit to the object in step (c) can be similar or even the same compared to the first distance, such that improving the resolution due to a change of the focal length predominates compared to a resolution improvement due to a change of the distance. The two distances can deviate from each other by a few percent, e.g., by less than 5% or less than 10% or less than 20%. However, it should be noted that the predetermined waypoint or the flight trajectory could also be varied or adapted according to embodiments.

In embodiments according to the first aspect of the present invention, the capturing unit includes at least one of a plurality of lenses, a zoom lens, a plurality of cameras and a plurality of camera lenses. Further, in step (a), the capturing unit uses a first camera, a first lens and/or a first camera lens with the first local length or sets the zoom lens to a first zoom setting according to the first focal length. Above that, in step (c), the capturing unit uses a second camera, a second lens and/or a second camera lens with the second focal length or sets the zoom lens to a second zoom setting according to the second focal length. These adaptations can be performed in an automated manner during the flight such that, for example, the feature of the object can be detected by flying along the object once. The zoom setting and/or the selection of the camera, the lens and/or the camera lens can be linked to the waypoints and/or a timing of the flight.

In embodiments according to the first aspect of the present invention, optically detecting the area again in the step (c) includes generating a plurality of partial images of the area, each with the second resolution. Accordingly, simply put, the plurality of partial images can form a raster image with higher resolution, such that, for example allocated to an image with the first resolution, a plurality of detailed images can be generated.

In embodiments according to the first aspect of the present invention, flying along the object is performed autonomously with an unmanned aerial vehicle, e.g. a drone including the capturing unit. Further, the unmanned aerial vehicle includes a computer, wherein step (b) includes evaluating the images by the computer of the unmanned aerial vehicle. Here, evaluating the images includes evaluating the images in an automated manner, the evaluation can therefore take place for example in a fully automated or partly automated manner. By providing the computing power by the aerial vehicle, for example, the feature of the object can be detected by flying along the object once, such that the method can be performed in a particularly time-efficient manner. Above that, by the computing power, the aerial vehicle can adaptively plan its own trajectory, for example in form of the waypoints based on the evaluation results. Thus, full autonomous detection of the feature of the object can be performed.

Embodiments according to the first aspect of the present invention comprise the following step (d), wherein step (d) includes transmitting the images generated in step (c) to an evaluation unit, e.g. for classifying or cataloging the detected features. The images with the higher resolution generated in step (c) can be transmitted to an evaluation unit, such as an external computer, for evaluating the features of the object, for example damages of the objects, such as cracks. This information can then be entered, for example, into an existing model of the object. Further, the evaluation unit can also send further instructions back to the unmanned aerial vehicle, for example when detecting a specific type of damage, approaching again and detecting the damage, for example with other measuring methods. In the case of a wind power plant, for example, electric measurement of the lighting protection device of the wind power plant could be performed based on image evaluation.

In embodiments according to the second aspect of the present invention, the object is approached in step (a), such that the capturing unit has a fixed distance to the object when generating an image and the partial images. Further, in step (a), the capturing unit generates the image with a first focal length and the partial images with a second focal length that is greater than the first focal length. In other words, increasing the resolution takes place by changing the focal length.

In embodiments according to the second aspect of the present invention, the capturing unit includes a zoom lens using a first zoom setting according to the first focal length when generating the image and using a second zoom setting according to the second focal length when generating the partial images. Changing the zoom setting can be performed during the flight such that both images with the first as well as with the second resolution can be taken from the same waypoints of the flight trajectory. Accordingly, this way of generating the partial images can be performed in a particularly time-efficient manner.

In embodiments according to the second aspect of the present invention, flying along the object with an unmanned aerial vehicle, e.g. a drone including the capturing unit is performed autonomously. Above that, step (b) includes transmitting the images and partial images generated in step (a) from the unmanned aerial vehicle to a computer, such as a laptop computer and evaluating the images by the computer. Evaluating the images includes automated evaluation of the images, evaluation of the images can be performed, for example, in a fully automated or partially automated manner. Further, step (c) includes providing the partial images of the image allocated to the area by the computer. Evaluation can be performed, for example, by methods of machine learning. Simply put, the inventive method generates classified images as well as detailed images in the form of the partial images and provides the same by the computer. Thereby, intuitive evaluation or assessment of the feature, for example a damage, can be performed.

In embodiments according to the second aspect of the present invention, flying along the object is performed autonomously with an unmanned aerial vehicle, e.g. a drone including the capturing unit. Above that, the unmanned aerial vehicle includes a computer, wherein step (b) includes evaluating the images and the partial images by the computer of the unmanned aerial vehicle. Evaluating the images (B1-B4) and the partial images (B11-B44) includes automated evaluation of the images (B1-B1) and the partial images (B11-B44). The images and partial images can be evaluated, for example in a partially automated or fully automated manner. Further, in step (c) the unmanned aerial vehicle transmits the partial images to an evaluation unit, e.g. for classifying or cataloging the detected features. By evaluating the images and the partial images by the unmanned aerial vehicle, during flying along the object, the feature of the object can already be detected with reduced time effort. The classified or cataloged features can then be provided by the evaluation unit for example, directed to a person for evaluating who can initiate again, for example during the flight of the aerial vehicle, further detections, e.g. with non-optical measurement methods (e.g. lightening protection measurement and/or humidity measurement) of relevant areas.

In embodiments according to the first and/or second aspect of the present invention, the feature to be detected includes a defect of the object or a predetermined element of the object. The defect can be, for example, a crack, a hole, rust infestation, paint damages or other optically detectable surface variations. Further, the feature can also be a predetermined element of the object, such as a characteristic geometry of the object, for example in the case of a wind turbine the wing tips or the rotor flanges or a specific device such as a rivet or a screw. In some applications, it can be advantageous to detect respective predetermined elements as accurately as possible, for example to construct a 3D model of the object that is as precise as possible or to exclude damages and norm deviations.

In embodiments according to the first and/or second aspect of the present invention, step (b) includes AI or machine learning. Such methods can evaluate or categorize images at high speed with little resource effort, for example with respect to the presence of a feature of an object. Above that, an inventive method with a known reference object or a known reference feature can be used for generating training data for respective methods. The AI or the machine learning can be used on its own or for supporting a person. Such methods allow huge time savings, in particular with respect to a large number of images to be evaluated for large objects, such as an oil platform or a wind turbine.

In embodiments according to the first and/or second aspect of the present invention, the object includes an energy generation plant, e.g. a wind power plant or a solar plant or an industrial plant, e.g. an oil platform, a factory plant, refinery or a building, e.g. a multi-story building or an infrastructure means, such as a bridge. Further, the object can also be a crane. In particular, an inventive method can be performed during operation, for example with respect to an industrial plant, without a person having to be put in danger or the operation having to be stopped.

In embodiments according to the first aspect and/or the second aspect of the present invention, the unmanned aerial vehicle, e.g. a drone is configured to transmit the plurality of images to an external computer, e.g. a laptop computer that classifies the generated images into images that do not include the feature and into images that include the feature. Further, the unmanned aerial vehicle is configured to receive information from the external computer that indicate the areas of the object to be optically detected with the second resolution. Based on the information of the external computer, the unmanned aerial vehicle can accordingly generate images of the respective areas with the second resolution. The communication as well as the usage of the information can take place during the flight, for example during flying along and generating the images with the first resolution of the object or during an intermediate stop for example between flying along the object for generating the images with the first resolution and approaching the object again for generating images of selected areas of the object with the second resolution. Further, the intermediate stop can be used for restoring the flight capability of the unmanned aerial vehicle, for example for changing the batteries of a drone. Above that, the computer can also provide trajectory planning of the unmanned aerial vehicle, for example for an autonomous flight and can form the above-discussed evaluation unit.

In embodiments according to the first and/or second aspect of the present invention, the unmanned aerial vehicle, e.g. a drone comprises a computer that is configured to evaluate the plurality of images to classify the generated images into the images that do not include the feature and into the images that include the feature. Thereby, the drone can be independent of a sufficiently fast communication connection to an external computer. Further, time savings can be obtained by evaluating the plurality of images during the flight.

### BRIEF DESCRIPTION OF THE DRAWINGS

Embodiments of the present invention will be detailed subsequently referring to the appended drawings, in which:

FIG. 1 is a schematic illustration of an object and a capturing unit with a flight trajectory according to an embodiment of the present invention;

FIG. 2 is a schematic illustration of a section of FIG. 1 with amended flight trajectory according to an embodiment of the present invention;

FIG. 3 is a schematic illustration of an image classification according to an embodiment of the present invention;

FIG. 4 is a schematic side view of a wind power plant having a damage that is detected with the help of embodiments according to the present invention;

FIG. 5 is a flow diagram of a method for detecting a feature of an object 20 according to an embodiment of the present invention; and

FIG. 6 is a flow diagram of a further method for detecting a feature of an object according to an embodiment of the present invention.

### DETAILED DESCRIPTION OF THE INVENTION

Before embodiments of the present invention will be discussed in more detailed below based on the drawings, it should be noted that identical, functionally equal or equal elements, objects and/or structures in the different figures are provided with the same or similar reference numbers, such that the description of these elements illustrated in different embodiments is inter-exchangeable or inter-applicable.

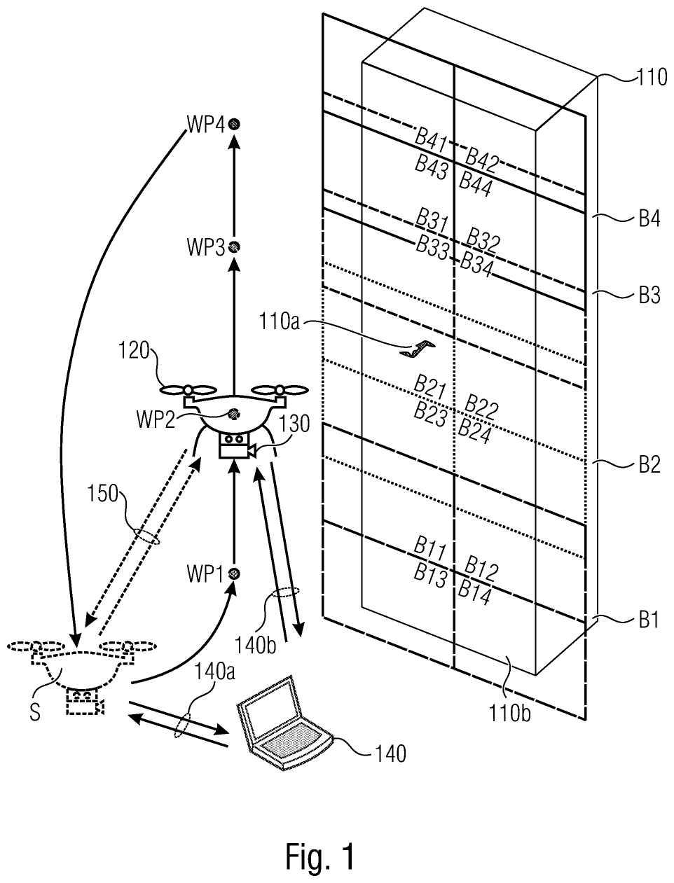

FIG. 1 shows an object 110, an unmanned aerial vehicle 120 with a capturing unit 130 as well as a computer 140. Here, the aerial vehicle 120 is to be considered as merely optional, as possible implementation of a moveable capturing unit, for example in the form of a drone with a camera.

Starting from a starting point S, the aerial vehicle 120 flies along the object to detect one or several features 110a. The flight trajectory is indicated by waypoints WP1 to WP4. The flight trajectory can originate for example from a preceding trajectory planning. Here, for example waypoint generation can be performed, for example by the computer 140, based on a 3D model of the object, which is provided to the aerial vehicle 120 via a connection 140a. Here, it should be noted that the computer 140 could also be part of the aerial vehicle 120, such that the aerial vehicle plans its own trajectory, for example autonomously. Further, the trajectory can also be manually predetermined by a human pilot, for example due to the lack of a 3D model of the object 110.

When flying along the object 110, the capturing unit 130 detects the front side 110b of the object 110 or generally a part of the object. Here, the capturing unit 130 generates a plurality of images B1-B4 with a first resolution, wherein each image represents at least partly a different area of the object 110 or the front side 110b of the object. Accordingly, the images B1-B4 can partly overlap as shown in FIG. 1 or, in other words, the same can comprise information on a partly equal image section or a partly equal area of the object. Further, the images might also not overlap. As an example in FIG. 1, each of the waypoints WP1-WP4 is associated to one of the images B1-B4. Simply put, a plurality of waypoints can be determined from where an object is detected, for example captured.

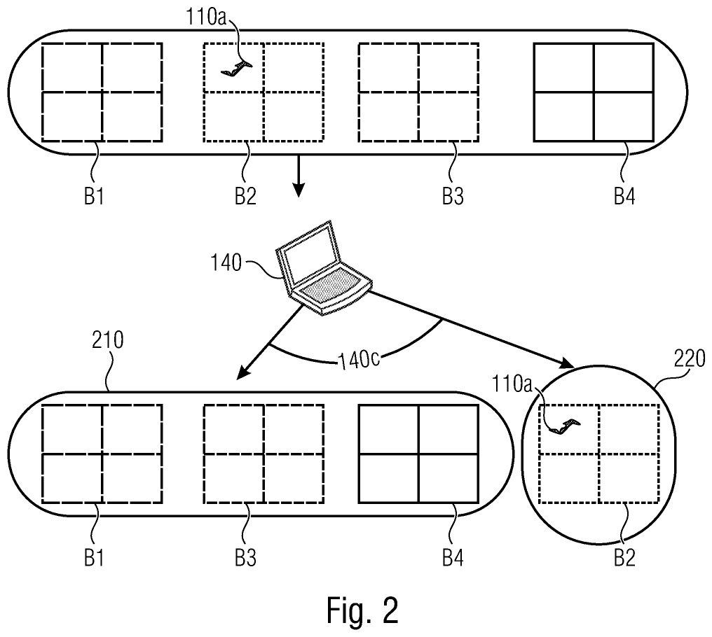

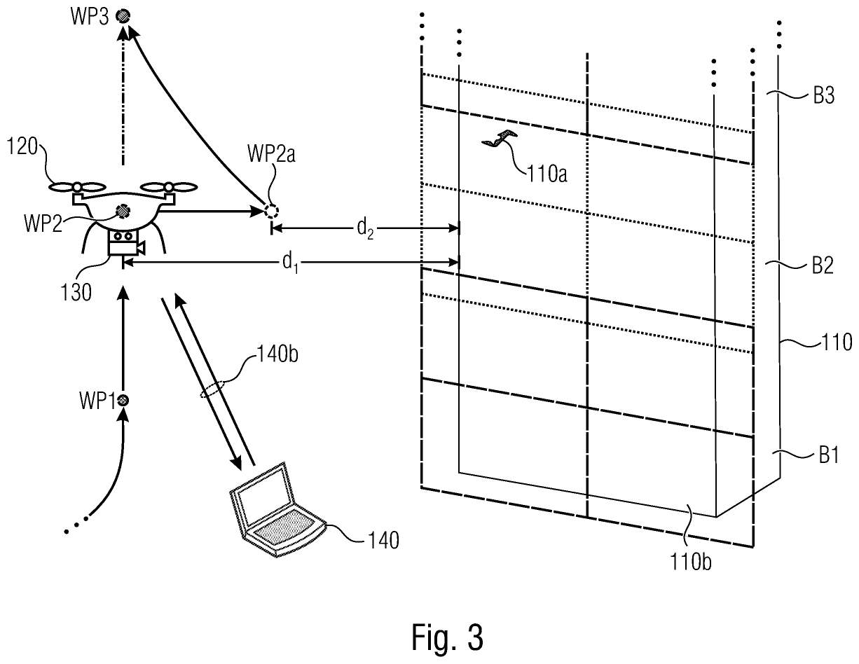

According to the invention, for detecting the feature 110a, a plurality of methods and method steps are available whose features, as long as not stated otherwise, are inter-exchangeable and can be used together in any combination. Some inventive options will be discussed below with the help of FIGS. 2 and 3. However, this does not represent a limiting list of method steps but merely serves for an improved understanding of inventive concepts and their configurations.

FIG. 2 shows the images B1-B4 with the same resolution. The images B1-B are classified 140c into images 210 that do not include the feature 110a including images B1, B3, B4 and into images 220 that include the feature 110a, including image B2. The classification is implemented in FIG. 2 as one example with the computer 140 but can be performed by any classification unit. The classification can in particular be implemented by methods of machine learning. The classification can for example be performed by artificial intelligence (AI).

Again, as shown in FIG. 1, the results of the classification can be communicated 140b during the flight to the aerial vehicle 120 or the capturing unit 130 or can be communicated 140a after flying along the object 110 and the subsequent landing at the starting point S. Again, it should be noted that the computer 140 or also a respective classification unit could be part of the aerial vehicle 120, such that a respective communication 140a, 140b is considered to be optional. Further, the bi-directionality of the communication 140a, 140b shown in FIG. 1 is also optional, any combination of information can be transmitted via the aerial vehicle to the computer or vice versa. Depending on existing hardware, a plurality of possible task distributions (for example with respect to image classification, calculation of waypoints, classification of the feature) can be realized between aerial vehicle 120 and computer 140 and the communication 140b, 140b can be configured accordingly.

Based on the classification, the capturing unit 130 can optically detect again the area of the object 110, which includes the feature by the image B2 allocated to the area on which the area 110a has been detected with a second resolution that is higher than the first resolution.

If the classification is performed during flying along the object 110, the aerial vehicle can stay on the waypoint WP2 after generating the image B2 and after detecting the feature on image B2 and can detect the respective area of the object again. However, the aerial vehicle 120 does not have to stay on the waypoint WP2 but, for example, can merely maintain a same or similar distance to the object 110. For increasing the resolution when detecting again, the capturing unit 130 can increase the focal length, for example by adapting a zoom setting or by changing a lens. Thereby, an image B21 with higher resolution can be generated, which is, for example, a partial image of the image B2. For this, apart from the evaluation regarding a classification of images B1-B4, which include the feature 110a, the position of the feature can be evaluated by using position and location data of the aerial vehicle 120 to direct the capturing unit 130 to the feature 110a for generating the image B21. Here, it should be noted that the image B21 does not necessarily have to include a partial area of the image B2. The area of the object detected with image B21 can be selected for example only in dependence on a position of the feature 110a, such that the image section of image B21 can be selected independently of areas of the images B1-B4.

If, for example, the positon of the feature 110a is not known, an amount of partial images B21-B24 can be generated with the second resolution. Further, also independent of a classification and detection of the feature 110a on the images B1-B4, a plurality of areas of the object or, for example, each area of the object can be detected by a plurality of partial images of the area, each with the second resolution (for example for image B1 the partial images B11-B14, for image B2 the partial images B21-B24 etc.).

Respective partial images can be transmitted, for example via the communication 140b to an evaluation unit, for example in the form of the computer 140, for example, for classifying or cataloging the detected feature 110a.

Alternatively, the classification of images B1-B4 can also take place after flying along the waypoints WP1-WP4 and subsequently landing on the starting point S. By the communication 140a, subsequently, based on the classification at allocated positon and/or location information about the feature 110a, a second flight trajectory 150 can be provided to the aerial vehicle 120. For easier understanding, FIG. 1 shows the trajectory 150 as flight from starting point S to waypoint WP2 and back to starting point S. At the waypoint WP2, the above-discussed detecting again of the area of the object takes place. Here, it should again be noted that an area of the object including the feature 110a can be captured with a single image B21 or with a raster of partial images of the image B2, for example including partial images B21-B24 with the second resolution. Increasing the resolution can again be obtained by changing a zoom setting or by changing the lens of the capturing unit 130. These adaptations can be performed, for example, manually during the landing, after flying along the object 110 for the first time and prior to approaching the object 110 via the flight trajectory 140. The flight itself can again take place autonomously or manually.

For increasing the resolution when detecting the object again, the aerial vehicle 120 or the capturing unit 130 can also reduce a distance to the object d. The same will be discussed below with reference to FIG. 3. FIG. 3 shows a section of FIG. 1 with the object 110, the aerial vehicle 120, the capturing unit 130 and the computer 140. The waypoint WP2 has a first distance d₁ to the object 110. For detecting again, the aerial vehicle 120 can approach the object on the waypoint WP2a, such that the distance is reduced to the distance d₂. Thereby, the object 110 or the area of the object comprising the feature 110a can be captured with a higher resolution, for example without changing a zoom setting or without changing a lens.

Adapting the trajectory of the aerial vehicle 120 can take place during the flight, as shown optionally in FIG. 3. By communication 140b with the computer 140, after classifying the image B2, the trajectory can be changed during the flight. Here, the capturing unit or the aerial vehicle can communicate the image B2 to the computer 140 and subsequently receive new waypoints WP2a. Alternatively, the aerial vehicle as mentioned above can itself include the computer 140 and perform classification and trajectory adaptation itself. Here, any combination is possible, such that the aerial vehicle or the capturing unit, for example, perform the classification individually, communicate the classification result to an external computer and can receive waypoints in return. A respective trajectory adaptation with distance reduction can also take place during an intermediate landing via the communication 140a of FIG. 1 according to the invention. Further, the flight trajectory can also consist a priori of waypoints with different distances to the object 100, such that, for example, independent of a classification of the images or a detection of the feature 110a, a raster of partial images (B11-B14, B21-B24, etc.) is generated for a plurality of areas of the object with the second resolution by reducing the distance.

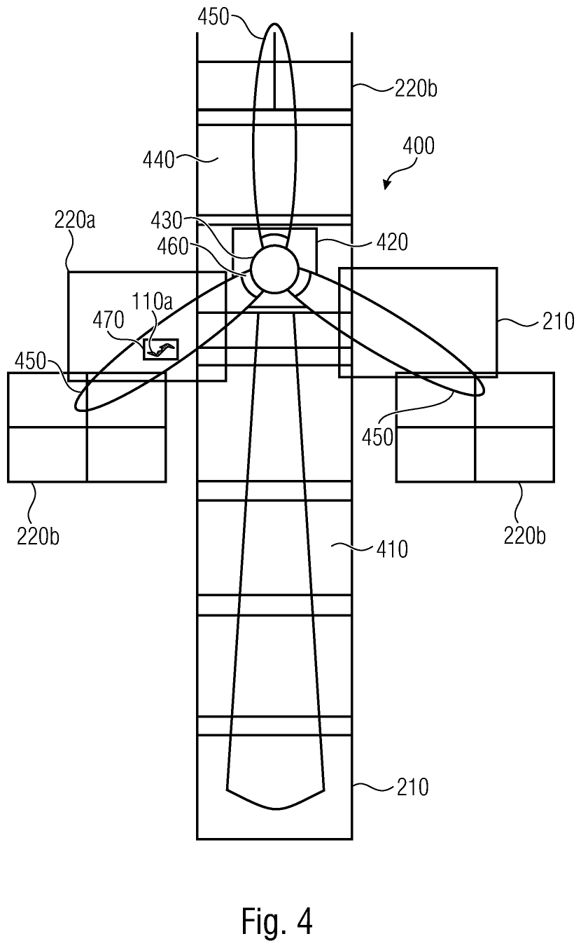

Further embodiments include an AI supported inspection of wind turbines with drones and will be discussed below based on FIG. 4. FIG. 4 shows a wind power plant 400 with a tower 410, a pod 420, a rotor 430, rotors or blades 440, rotor blade or blade tips 450 and rotor blade flanges 460. One of the rotors 440 has a damage 110a. This damage 110a or the defect can be a crack, for example. Regarding defect detection, the damage 110a can be the feature of the wind power plant that is to be detected. Regarding a generation of a model of the wind power plant 400, e.g., by a calibration flight of a drone, the blade tips 450 and/or the rotor blade flanges 460 can be features of the wind power plant 400 that are to be detected. From the detection, for example, via a known position of the aerial vehicle at the time of the detection and the mapping geometry, a 3D model of the wind power plant can be generated. From this 3D model, again waypoints can be generated for autonomous inspection flights. Above that, detected images 210 are shown that do not include the feature and detected images 220 that include the feature in the form of image 220a for the case that the feature is the damage 110a and alternatively or additionally images 220b for the case that the feature are the blade tips 450.

For the case that the feature is the damage 110a, the partial image 470 is shown as an example for illustration. According to embodiments, areas with images 220a including the feature can be detected again with higher resolution, wherein, however, not the entire previously scanned area of the object has to be scanned again but also merely a partial area of the original image section or the area of the object can be detected. Here, it should noted, in comparison to FIG. 1, generally, in embodiments not necessarily an image Bx has to be completely divided into partial images Bxx by renewed detection with increased resolution. Further, a respective partial image 470 does also not have to be completely within the image with the first resolution from the evaluation of which the position of the feature has been detected. Simply put, in comparison, “raster detection” is indicated for detecting the blade tips 450 for the images 220b.

The basic concept of defect detection or pattern detection according to embodiments takes place by detecting and subsequently excluding the defect-free areas with the help of AI. In other words, defect detection i.e. for example, detection of the damage 110a, takes place by detecting defect-free areas (image 210), which in this context are referred to as patterns, wherein with this pattern detection for example the defect 110a can be inferred. Subsequently, the areas of the wind power plant 400 or patterns that have been detected by the AI as not defect-free, i.e., defective and therefore not excluded are approached again for generating high-resolution defect images. For approaching again, automatic generation of waypoints can be used. With reference to FIG. 2, areas of the object or the wind power plant 400 associated with the images 210 are excluded and areas associated with images 210 are approached again. With reference to FIG. 1, the high-resolution defect images, can, for example be the image with the second resolution B21 or the plurality of partial images B21-B24. As already discussed above, generation of high-resolution defect images can take place by using zoom lenses and/or a closer approach to the areas that have been detected as not defect-free. Further, an exchange of the lens of the capturing unit is also possible.

Regarding the wind power plant 400, the AI-supported image/defect detection or pattern detection can be used, for example, in the following tasks or missions.
1. Calibration flight
2. Tower inspection
3. Blade inspection

According to embodiments, the AI support can be used in several stages. As example, three stages will be explained below, wherein features of the individual stages are inter-exchangeable or combinable in any manner, as far as not indicated otherwise. They are merely to explain the idea regarding the usage of AI with respect of feature detection and are therefore not to be considered as being limiting.

Stage 1:

After landing of the drone and transmitting the image data, subsequent further processing of the image data by the AI is performed, which computes on a remote computer (laptop) or runs on the same. The AI generates waypoints for inspection or an inspection flight, for example, after a calibration flight or waypoints for a defect flight, i.e. approaching the wind power plant 400 for detecting the defect 110a or another feature (for example rotor tips 540) with increased resolution after an inspection flight.

The drone performs the inspection flight autonomously and transmits the images to the remote computer after the landing, for example during a battery change. The image/defect detection or pattern detection takes place on the remote computer. The results, for example waypoints for a subsequent inspection flight, for example based on a generically generated CAD model of the wind power plant after the calibration flight or waypoints for the subsequent defect flight, i.e., approaching the detected defects 110a for example at a short distance and capturing the defects 100a with high resolution are retransmitted to the drone after the calculation.

Stage 2 Local Intelligence:

AI runs or computes on an additional computing unit in real time on the drone and controls the inspection flight after calibration or the defect approach during the inspection flight. The additional computing unit can be, for example, an add on GPU (graphics processing unit) Board (additional graphic processor board) or CPU (central processing unit) or specific AI boards. Further, the above-described computer can also be part of the drone and hence provide the hardware for operating the AI.

The drone is provided with its own local intelligence, for example by the additional computing unit and performs calculations onboard, for example locally on its own drone hardware in real time. Above that, the drone can perform actions, for example calculation of the waypoints for the subsequent inspection flight directly during the calibration flight and further perform the inspection flight, for example, directly afterwards. Defects are detected in real time and instantaneous direct approaching or zooming in at the detected defects and capturing the defect with respective high resolution takes place. Subsequently, the inspection flight is continued up to the next defect.

By using a 300 DJI drone 1 with P1 full format camera and 50 mm lens or alternatively a zoom lens, the inspection flight can be performed, for example, with a distance to the blade 440 of 8 m and approaching the detected defect again with a distance of 3 m.

After the inspection flight is terminated, the drone transmits the data, for example all image data of the inspection flight having, for example, a low or the first resolution (for example corresponding to images B1-B4 of FIG. 1) and all generated defect or partial images with, for example, a high or the second resolution (for example one or several of the partial images B11, . . . , B44 of FIG. 1) to a cloud or to an external computer. From the defect images, the defects 110a can be categorized by an operator and the defect protocols can be generated interactively.

Stage 3 Evaluation:

Detected and high-resolution defect images are categorized by the AI. The defect images stored in the cloud can be automatically categorized with the help of AI and the defect protocols can be generated automatically. According to the different stages of the AI support, the AI can be used as discussed below in the three above stated tasks.

1. Calibration flight: in embodiments, the basic principle of the AI support is the optical recognition and detection of the optical recognition and detection of the blade tips 450 by AI and the calculation of the position of the blade tips 450 as well as the optical recognition and detection of the blade flanges 460 by AI and calculation of the positions, distances and angles of the blade flanges 460.

Alternatively or additionally, the pitch angles of the blades can be detected and/or calculated. With these values, final calculation or modification of a generic model, for example a CAD model of the wind power plant 400 including the positioning and orientation of the plant as well as the bending of the blades 440 can take place. From these data, the waypoints for the inspection flights can be calculated. This can take place with intermediate landing (remote—stage 1) or in real time without intermediate landing (local intelligence—stage 2).

2. Tower inspection: In tower inspection, the usage of AI can be particularly advantageous due to the large amount of images. Based on the above-stated hardware (300 DJI drone with P1 full format camera and 50 mm lens or alternatively zoom lens) for example 400 images can be generated at a distance of 9 m between capturing unit and wind power plant with a resolution of 1.25 pixel/mm at a tower height of 145 m. On the other hand, the possible variations of damages 110a or in other words defect classes are manageable and the defects mostly large-scale, such that the AI can be reached relatively quickly.

3. Blade inspection: Inventive methods for blade inspection are similar to the methods for tower inspection, for example at a significantly lower number of images. For obtaining, for example, needed or advantageous resolution of approximately 1.6 pixel/mm for a first inspection, for example for the usage of AI, for example at a blade length of approximately 7 m at distance of the drone or capturing unit of 7 m to the blade approximately 25 images can be generated or needed per side. For obtaining an improved resolution, for example the above-discussed second resolution, for example a resolution of more than 3.5 pixel/mm requested by a reviewer, detected defects should be approached again or immediately at a distance of approximately 3 m to the blade. However, as described above, for obtaining the improvement of the resolution a change of a zoom setting or a change of the used lens could be performed.

Based on the following table, aspects of embodiments according to the invention will be summarized briefly again and their advantages are illustrated based on numerical examples. The numerical values are based on the above-described 300 DJI drone with P1 full format camera and 50 mm lens. The image sensor has a width of 35.9 mm with 8197 pixel and a height of 24 mm with 5460 pixel.

| P1 | P1 | P1 | | P1 | P1 | P1 | |
|---|---|---|---|---|---|---|---|
| Image | Full | Distance | | Image | Section | Pixel/ | |
| sensor | format | | | | | mm | |
| Width | Height | Drone | | Width | Height | | |
| 35.9 mm | 24 mm | | | mm | mm | | |
| Pixel | 45 Mio | | | | | | |
| 8.197 | 5.460 | | | | | | |
| Tower | e.g. | 9 | m | 6.400 | 4.320 | 1.28 | 38 Images |
| Inspection | Height | | | | | | per Tower |
| | 145 m | | | | | | Side |
| | Total | | | | | | 8 Blades |
| | | | | | | | per 45 |
| | | | | | | | Degree |
| | 304 | | | | | | 20 cm |
| | Images | | | | | | Overlap |
| Blade | e.g. | 7.0 | m | 5.026 | 3.360 | 1.63 | 25 Images/ |
| Inspection | Length | | | | | | Blade |
| | 70 m | | | | | | Side |
| | Total | | | | | | 3 Sides |
| | 75 | | | | | | 20 cm |
| | Images | | | | | | Overlap |
| Defect | | 3.0 | m | 2.120 | 1.420 | 3.87 | |
| Flight | | | | | | | |
| Calibra- | | 25 | m | 18.000 | 12.000 | 0.46 | |
| tion | | | | | | | |

In the table, the above-described possible tasks or missions of inventive methods regarding a wind power plant are plotted in the form of a tower inspection, a flight inspection and a calibration (calibration flight). Further, an example for an above-described defect flight is entered. For each of these tasks, in the fourth column, a distance of the aerial vehicle or the drone to the wind power plant, in the fifth column, the image width covered by the respective image section with respect to the surface of the wind power plant in mm, in the sixth column, the image height covered by a respective image portion regarding the surface of the wind power plant in mm and in the seventh column, the respective resolution in pixel/mm is entered.

The inspection of a wind power plant can start, for example with the calibration or the calibration flight. For this, a pilot flies along the wind power plant at a distance of 25 m with the aerial vehicle, for example the drone. Here, the wind power plant is optically detected, wherein an image in an image area corresponds to a width of 18 m and a height of 12 m in reality. Accordingly, images of this optical detection have a resolution of 0.46 pixel/mm. Based on known position and location information of the aerial vehicle connected to the captured images, by recognizing characteristic features of the wind power plant, such as the blade tips, a CAD model of the wind power plant can be generated or a generated model can be modified. Due to the high distance and the low resolution, this step can be performed with little time effort. Detecting the features can be performed in particularly by using methods of machine learning. It should be noted that the distance could also be in an area or interval such that the distance is for example at most 25 m or at most 20 m or is in a range of 20 m to 25. Further, the distance can also be for example 20m.

Based on the CAD model, subsequently, waypoints for the inspection flights for example for tower inspection and/or blade inspection can be generated. These waypoints can also again be generated by using AI. Both the evaluation as well as the waypoint generation can be performed after landing after the calibration flight or also during the calibration flight by the aerial vehicle itself. In order to be able to detect defects with sufficient accuracy, in the for example subsequently autonomously performed inspection flights, the distance of the aerial vehicle to the wind power plant is reduced. For blade inspection, for example a distance of 7 m can be set, such that a generated image corresponds to a width of approximately 5 m and a height of approximately 3.3 m in reality, which results in a resolution of 1.63 pixel/mm. In 25 images per blade side with 3 sides and an overlap of 20 cm, with an exemplary length of the blades of 70 m, 75 images result. Analogously, during tower inspection, 304 images result at a resolution of 1.28 pixel/mm.

For evaluating the images of the inspection flights, again, AI can be used. As already mentioned above, the same can already itself categorize the images during the flight and divide them into images showing damages and into images showing no damages. Alternatively, this can also take place after landing on an external computer. The large advantage of methods of machine learning becomes obvious based on the large number of images, which would result in a high time effort when evaluation is performed by persons. By the inventive idea of separately detecting areas of the wind power plant comprising damages again, direct time-intensive and data-intensive generation of images with high resolution during tower and/or blade inspection or for the entire surface and/or blades can be omitted. By the position and location information of the drone that can be connected to the respective images on which damages have been detected, respective parts can be approached again during a defect flight. Alternatively, detecting can take place with the second or higher resolution also during the tower or blade inspection. The distance of the aerial vehicle to the object can be reduced to 3 m or a respective lens can be attached (e.g. during an intermediate landing) or a zoom setting (e.g. during the flight) can be adapted accordingly. Thereby, a resolution of 3.87 pixel/mm can be obtained.

With such a high resolution, even smallest damages can be detected and categorized. Thus, for example strict legal requirements regarding the safety of plants can be implemented. By reducing the number of detailed images during renewed optical detection with the increased or second resolution, an inventive method is combined with low time and resource effort due to the preselection of the areas of the wind power plant to be considered. Above that, a respective method is very well scalable due to the usage of a plurality of autonomously flying drones. A further option of scaling is the accuracy, wherein both the inspection flights and the defect flights can be improved with even further reduced distances and improved image sensors. Further, also with zoom lenses, more images with higher resolution can be generated.

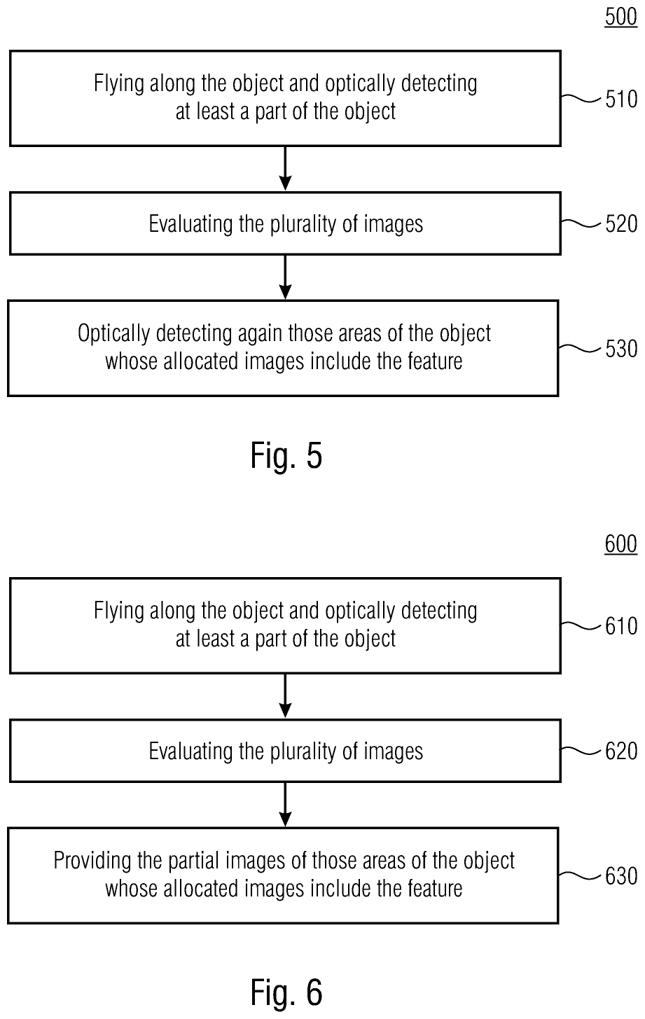

In the following FIGS. 5 and 6 the inventive methods will be briefly summarized.

FIG. 5 shows a flow diagram of a method for detecting a feature of an object according to an embodiment of the present invention. FIG. 5 shows the method steps 510-530 in an order, which is merely exemplary. Accordingly, the method steps can also be used in amended order. Step 510 includes flying along the object and optically detecting at least part of the object at least by a capturing unit 130 with a first resolution to generate a plurality of images, wherein each image represents an at least partly different area of the object. Step 520 includes, for example, automated evaluation of the plurality of images to classify the generated images into images that do not include the feature and into images that include the feature. Step 530 includes optically detecting again those areas of the object whose allocated images include the feature with a second resolution that is higher than a first resolution.

FIG. 6 shows a flow diagram of a further method for detecting a feature of an object according to an embodiment of the present invention. FIG. 6 shows the method steps 610-630 in an order, which is merely exemplary. The method steps can accordingly be applied in amended order. Step 610 includes flying along the object and optically detecting at least a part of the object by at least one capturing unit to generate a plurality of images, wherein each image represents an at least partly different area of the object and wherein, for one area, an image with the first resolution and a plurality of partial images each, with a second resolution that is higher than the first resolution are generated. Step 620 includes, for example, automated evaluation of the plurality of images to classify the generated images into images that do not include the feature and into images that include the feature. Step 630 includes providing the partial images of those areas of the object whose allocated images include the feature.

Further, it should be noted that optically detecting according to embodiments could also include detection in the infrared range, for example by means of infrared cameras.

All listings of materials, environmental influences, electric characteristics and optical characteristics stated herein are to be considered as exemplary and not as limiting.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be performed by a hardware apparatus (or using a hardware apparatus), such as a microprocessor, a programmable computer or an electronic circuit. In some embodiments, some or several of the most important method steps may be performed by such an apparatus.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may, for example, be stored on a machine-readable carrier.

Other embodiments comprise the computer program for performing one of the methods described herein, wherein the computer program is stored on a machine readable carrier.

In other words, an embodiment of the inventive method is, therefore, a computer program comprising a program code for performing one of the methods described herein, when the computer program runs on a computer.

A further embodiment of the inventive method is, therefore, a data carrier (or a digital storage medium or a computer-readable medium) comprising, recorded thereon, the computer program for performing one of the methods described herein. The data carrier, the digital storage medium, or the computer-readable medium are typically tangible or non-volatile.

A further embodiment of the inventive method is, therefore, a data stream or a sequence of signals representing the computer program for performing one of the methods described herein. The data stream or the sequence of signals may, for example, be configured to be transmitted via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory device or a similar device, for example. The apparatus or the system may include a file server for transmitting the computer program to the receiver, for example.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

The apparatuses described herein may be implemented, for example, by using a hardware apparatus or by using a computer or by using a combination of a hardware apparatus and a computer.

The apparatuses described herein or any components of the apparatuses described herein may be implemented at least partly in hardware and/or software (computer program).

The methods described herein may be implemented, for example, by using a hardware apparatus or by using a computer or by using a combination of a hardware apparatus and a computer.

The methods described herein or any components of the methods described herein may be performed at least partly by hardware and/or by software.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. A method for detecting a damage of an object, comprising:
(a) flying along the object and optically detecting at least a part of the object by at least one capturing unit with the first resolution to generate a plurality of images, wherein each image represents an at least partly different area of the object,
(b) evaluating the plurality of images to classify the generated images into images that do not comprise the damage and into images that comprise the damage, and
(c) optically detecting again those areas of the object whose allocated images comprise the damage with a second resolution that is higher than the first resolution.

2. The method according to claim 1, wherein
step (b) is performed after flying along the object, and
step (c) comprises approaching those areas of the object whose allocated images comprise the damage.

3. The method according to claim 2, wherein
in step (a) and in step (c), the capturing unit generates one image each with the same focal length,
in step (a), the object is approached such that the first capturing unit has a first distance to the object when generating an image, and
in step (c), the object is approached such that the capturing unit has a second distance to the object that is lower than the first distance when generating an image.

4. The method according to claim 2, wherein
in step (a) and in step (c), the object is approached such that the capturing unit has the same or similar distance to the object when generating an image,
in step (a), the capturing unit generates an image with a first focal length, and
in step (c), the capturing unit generates an image with a second focal length that is greater than the first focal length.

5. The method according to claim 2, wherein optically detecting the area again in step (c) comprises generating a plurality of partial images of the area, each with the second resolution.

6. The method according to claim 2, wherein
position and/or location information of the capturing unit is allocated to each image generated in step (a), and
in step (c), the areas of the object that are to be flown along are determined by using the position and/or location information of the images comprising the damage.

7. The method according to claim 2, wherein
an unmanned aerial vehicle, such as a drone comprising the capturing unit, flies along the object, and
step (b) comprises transmitting the images generated in step (a) from the unmanned aerial vehicle to a computer, for example a laptop computer, and evaluating the images by the computer; and
evaluating the images comprises evaluating the images in an automated manner.

8. The method according to claim 7, wherein
in step (a), the unmanned aerial vehicle flies along the object autonomously,
step (b) comprises generating waypoints by using the position and/or location information of the images comprising the damage and transmitting the waypoints to the unmanned aerial vehicle, and
in step (c), the unmanned aerial vehicle approaches the areas of the object autonomously by using the waypoints.

9. The method according to claim 2, wherein
an unmanned aerial vehicle, e.g. a drone comprising the capturing unit, flies along he object autonomously,
the unmanned aerial vehicle comprises a computer, wherein step (b) comprises evaluating the images and generating waypoints by using the position and/or location information of the images comprising the damage by the computer of the unmanned aerial vehicle, wherein evaluating the images comprises evaluating the images in an automated manner, and
in step (c), the unmanned aerial vehicle approaches the areas of the object autonomously by using the waypoints.

10. The method according to claim 1, wherein flying along the object in step (a) is flying along the object autonomously by an unmanned aerial vehicle, wherein the unmanned aerial vehicle comprises the at least one capturing unit; and
wherein step (b) comprises generating waypoints by using the position and/or location information of the images comprising the damage and transmitting the waypoints to the unmanned aerial vehicle; and
step (c) comprises flying along the area of the object autonomously by using the waypoints.

11. The method according to claim 1, wherein steps (a) to (c) are performed during flying along the object such that
in step (a), an image of an area is generated,
in step (b), the image generated in step (a) is classified for a further area prior to generating an image,
when the image is classified as comprising the damage in step (b), prior to generating the further image, the area is optically detected again in step (c) before an image is generated for the further area and
when the image is classified as not comprising the damage in step (b), an image is generated for the further area.

12. A method for detecting a damage of an object, the method comprising:
(a) flying along the object and optically detecting at least a part of the object by at least one capturing unit to generate a plurality of images, wherein each image represents an at least partly different area of the object, and wherein, for one area, an image with the first resolution and a plurality of partial images, each with a second resolution that is higher than a first resolution, are generated,
(b) evaluating the plurality of images to classify the generated images into images that do not comprise the damage and into images that comprise the damage, and
(c) providing the partial images of those areas of the object whose allocated images comprise the damage.

13. The method according to claim 12, wherein
an unmanned aerial vehicle, e.g., a drone comprising the capturing unit, flies along the object autonomously,
step (b) comprises transmitting the images and partial images generated in step (a) from the unmanned aerial vehicle to a computer, e.g., laptop computer, and evaluating the images by the computer, wherein evaluating the images comprises evaluating the images in an automated manner and
step (c) comprises providing the partial images of the area allocated to the image by the computer.

14. The method according to claim 12, wherein
an unmanned aerial vehicle, e.g., a drone comprising the capturing unit, flies along the object autonomously,
the unmanned aerial vehicle comprises a computer, wherein step (b) comprises evaluating the images and the partial images by the computer of the unmanned aerial vehicle, wherein evaluating the images and the partial images comprises evaluating the images and the partial images in an automated manner and
in step (c), the unmanned vehicle transmits the partial images to an evaluating unit, e.g., for classifying or cataloging the detected damages.

15. The method according to claim 1, wherein step (b) comprises AI or machine learning.

16. An unmanned aerial vehicle, e.g., drone for detecting a damage of an object, comprising:
at least one capturing unit for generating images by optical detection,
wherein the unmanned aerial vehicle can be controlled to
fly along the object and to optically detect at least part of the object by the capturing unit with a first resolution to generate a plurality of images, wherein each image represents an at least partly different area of the object and
optically detect again those areas of the object whose allocated images comprise the damage with a second resolution that is higher than a first resolution;
wherein the unmanned aerial vehicle is configured to
transmit the plurality of images to an external computer, e.g., laptop computer that classifies the generated images into images that do not comprise the damage and into images that comprise the damage,
receive information from the external computer that indicate the areas of the object to be optically detected by the second resolution, or
wherein the unmanned aerial vehicle comprises a computer that is configured to evaluate the plurality of images to classify the generated images into the images that do not comprise the damage and into the images that comprise the damage.

17. An unmanned aerial vehicle, e.g., drone, for detecting a damage of an object comprising:
at least one capturing unit for generating images by optical detection,
wherein the unmanned aerial vehicle can be controlled to
fly along the object and optically detect at least a part of the object by the capturing unit to generate a plurality of images, wherein each image represents an at least partly different area of the object and
generate, for each area, an image with a first resolution and a plurality of partial images, each with a second resolution that is higher than the first resolution.

18. A system for detecting a damage of an object comprising:
an unmanned aerial vehicle, e.g., a drone,
wherein the unmanned aerial vehicle can be controlled to fly along the object to optically detect at least a part of the object by at least one capturing unit with a first resolution to generate a plurality of images, wherein each image represents an at least partly different area of the object,
wherein the system is configured to evaluate the plurality of images to classify the generated images into images that do not comprise the damage and into images that comprise the damage and
wherein the unmanned aerial vehicle can be controlled to optically detect again those areas of the object whose allocated images comprise the damage with a second resolution that is higher than a first resolution.

19. The system according to claim 18, wherein the unmanned aerial vehicle comprises the at least one capturing unit and wherein the unmanned aerial vehicle can be controlled to
fly along the object autonomously and
approach those areas of the object autonomously whose allocated images comprise the damage by using the waypoints; and
wherein the unmanned aerial vehicle is configured to transmit the plurality of images to a computer;
wherein the system comprises a computer; and
wherein the computer is configured to evaluate the plurality of images at least partly in an automated manner to classify the generated images into images that do not comprise the damage and into images that comprise the damage and
wherein the computer is configured to generate waypoints by using the position and/or location information of the images comprising the damages; and
wherein the computer is configured to transmit the waypoints to the unmanned aerial vehicle.

20. A system for detecting a damage of an object, comprising:
an unmanned aerial vehicle, e.g., drone,
wherein the unmanned aerial vehicle can be controlled to
fly along the object and optically detect at least a part of the object by the capturing unit to generate a plurality of images, wherein each image represents an at least partly different area of the object and
generate, for each area, an image with a first resolution and the plurality of partial images, each with a second resolution that is higher than the first resolution,
wherein the system is configured to
evaluate the plurality of images to classify the generated images into images that do not comprise the damage and into images that comprise the damage and
provide the partial images of those areas of the object whose allocated images comprise the damage, e.g., for classifying or cataloging the detected damages.
